(19) United States
(12) Patent Application Publication
(10) Pub. No.: US 2017/0169507 A1
(43) Pub. Date: Jun. 15, 2017

(54) FRACTIONAL BANKING FOR ACCOUNT HOLDERS

(71) Applicants: Theodore Phillip Skaarup, Walla Walla, WA (US); Luke Skaarup, Walla Walla, WA (US)

(72) Inventors: Theodore Phillip Skaarup, Walla Walla, WA (US); Luke Skaarup, Walla Walla, WA (US)

(21) Appl. No.: 15/381,059

(22) Filed: Dec. 15, 2016

Related U.S. Application Data
(60) Provisional application No. 62/267,706, filed on Dec. 15, 2015.

(51) Int. Cl. G06Q 40/02

(52) U.S. Cl. CPC G06Q 40/02

(57) ABSTRACT

Fractional banking for account holders is provided. An example system enables a bank account holder to subdivide the bank or credit account into subaccounts based on the account holder's specifications and issue blank checks, debit cards, credit cards, and gift certificates for the customized subaccounts. An example system extends a user interface for creating subaccounts within a master bank account of the user, assigning respective account numbers to each subaccount, assigning respective access devices, checks, or payment cards to each subaccount, and allotting assets of the master bank account to each subaccount. The system may statically partition assets between accounts, or dynamically allocate cash or available credit among accounts. The account holder can issue debit or credit cards for the subaccounts, and subject the cards to filters and spending rules specified by the account holder, such as custom expiration date, custom credit ceiling, dates and hours usable, and the like.

### RELATED APPLICATIONS

This application claims the benefit of priority to U.S. Provisional Patent Application No. 62/267,706 to Skaarup, filed Dec. 15, 2015 and incorporated herein by reference in its entirety.

### BACKGROUND

Credit and debit cards have become vital to retail economy. Efforts to prevent theft of account information have met with some success. Historically, most prevention efforts have emphasized securing the access device (i.e., the credit card) itself or securing the network that transmits purchase information. Little emphasis, other than education, has been placed on the cardholder's or account holder's ability to mitigate theft or fraud.

### SUMMARY

Fractional banking for account holders is provided. An example system enables a bank account holder to subdivide the bank or credit account into subaccounts based on the account holder's specifications and issue blank checks, debit cards, credit cards, and gift certificates for the customized subaccounts. An example system extends a user interface for creating subaccounts within a master bank account of the user, assigning respective account numbers to each subaccount, assigning respective access devices, checks, or payment cards to each subaccount, and allotting assets of the master bank account to each subaccount. The system may statically partition assets between accounts, or dynamically allocate cash or available credit among accounts. The account holder can issue debit or credit cards for the subaccounts, and subject the cards to filters and spending rules specified by the account holder, such as custom expiration date, custom credit ceiling, dates and hours usable, and the like.

This summary is not intended to identify key or essential features of the claimed subject matter, nor is it intended to be used as an aid in limiting the scope of the claimed subject matter.

### BRIEF DESCRIPTION OF THE DRAWINGS

Certain embodiments of the disclosure will hereafter be described with reference to the accompanying drawings, wherein like reference numerals denote like elements. The figures illustrate various implementations described herein and are not meant to limit the scope of various technologies.

FIG. 1 is a diagram of an example master bank account partitioned into multiple subaccounts.

FIG. 2 is a block diagram of an example banking system including a fractional account manager.

FIG. 3 is a diagram of example access devices linked to multiple subaccounts.

FIG. 4 is a diagram of a virtual credit card generated by the example fractional banking system.

FIG. 5 is a diagram of an example transaction request path.

FIG. 6 is a diagram of a corpuscular transfer of a subaccount from a first card holder to a second card holder.

FIG. 7 is a flow diagram of an example method of fractional banking.

FIG. 8 is a flow diagram of an example method of configuring subaccounts in fractional banking.

FIG. 9 is a flow diagram of another example method of configuring subaccounts in fractional banking.

### DETAILED DESCRIPTION

Overview

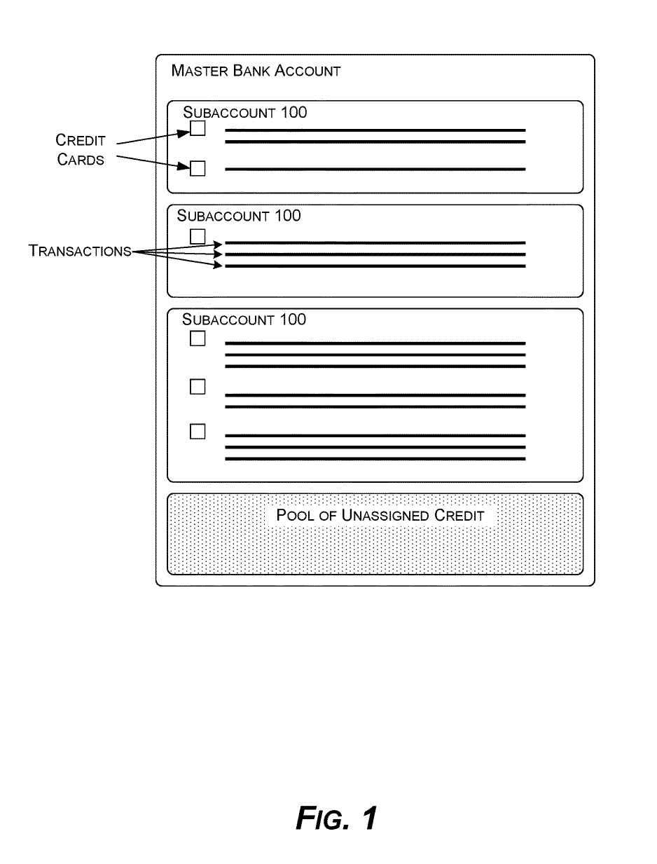

This disclosure describes fractional banking for account holders. Fractional Banking provides an account holder with flexibility in the control of their financial assets. As shown in FIG. 1, an example system allows an account holder to create subaccounts 100 from a main master account provided by a bank. The subaccounts 100 can have their own credit limits and customized spending rules. Firewalls between subaccounts 100 contain theft of credit card information from other accounts, limiting risk and allowing for the account holder to assign risk.

Fractional banking also allows for the account holder to self-issue credit cards, debit cards, checkbooks, and so forth, all which can be linked to individual subaccounts of the main bank account.

Accounting can be simplified. Spending is also easy to trace and control. An example fractional banking system is robust and scalable. The example system can be deployed from private individual accounts to multinational corporations. The example fractional banking system can be fully compatible with current credit card and ATM networks and systems. In an implementation, modifications to established banking networks are not required.

Example Systems

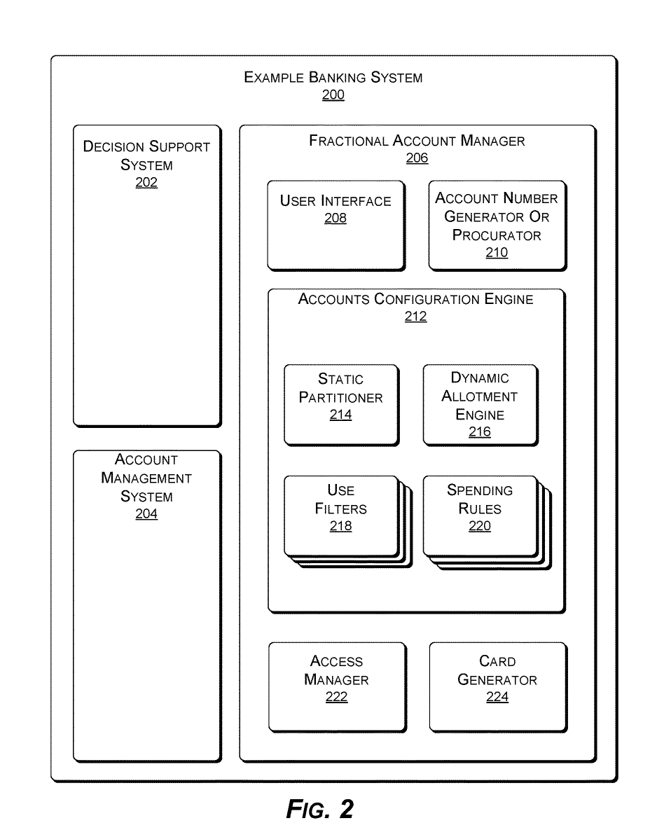

FIG. 2 shows an example banking system 200. The example banking system 200 includes multiple example components. For example, a decision support system (DSS) 202 can provide conventional resources supporting transactions made to and from each account at a bank. An account management system 204 can provide conventional and fractional bookkeeping and tracking of transactions and balances.

An example fractional account manager 206 associated with the account management system 204 includes a user interface 208, or user interface controller, for interacting with an account holder, and for placing the creation and control of subaccounts 100 in the hands of the account holder. An account number (generator) procurator 210 procures new account numbers from a bank, or generates new account numbers with permissions from a bank or clearinghouse. An accounts configuration engine 212 allows an account holder to create, remove, and configure subaccounts 100. In an implementation, the subaccounts are under or within a master bank account. The accounts configuration engine 212 may include a static partitioner 214, a dynamic allotment engine 216, use filters 218, and spending rules 220, for example.

The fractional account manager 206 may also include an access manager 222, which associates each subaccount 100 with an access device, such as a mobile application, a set of checks, a debit card, or a credit card. A card generator 224 may create debit or credit cards on the spot at the account holder's initiative, each card corresponding to a subaccounts 100.

An example banking system 500 includes a decision support system 202 associated with a bank, an account management system 204 coupled with the decision support system 202, the account management system 204 administering a master bank account for an account holder. A fractional account manager 206 is associated with the account management system 204 and is under control of the account holder via a user interface 208 extendable from the fractional account manager 206 to the account holder for receiving selections as user input.

An accounts configuration engine 212 subdivides at least a part of the master bank account into one or more subaccounts 100, based on the user input. The accounts configuration engine 212 may assign a respective account number to each of the one or more subaccounts 100. The accounts configuration engine 212 may also assign a respective access device, a set of checks, or a payment card to each of the one or more subaccounts 100 based on the user input. The accounts configuration engine 212 allots an asset of the master bank account to at least one of the one or more subaccounts 100, based on the user input.

In one example implementation, a static partitioner 214 divides total assets of the master bank account statically between the master bank account and the one or more subaccounts 100 based on the user input. Assets of the master bank account may be a total available credit, and the total available credit is statically partitioned between the master bank account and the one or more subaccounts 100 based on the user input. In another example implementation, a dynamic allotment engine 216 dynamically assign assets of the master bank account between the master bank account and the one or more subaccounts 100 based on the user input. In one scenario, the dynamic allotment engine 216 may allot the assets to the master bank account and to each of the one or more subaccounts on a first-come-first-serve basis. When at least part of the assets are used by the master bank account or the one or more subaccounts 100, the dynamic allotment engine 216 dynamically adjusts a respective available credit for each of the master bank account and the one or more subaccounts 100.

The fractional account manager 206 may enable the account holder to assign one or more use filters 218 or spending rules 220 to one or more of the subaccounts 100 based on the user input. Use filters 218 may incorporate a spending rule 220, or may designate dates that a subaccount 100 is usable, specify hours of the day that the subaccount 100 is usable, limit the amount that can be spent or charged during certain hours, limit locations where the subaccount 100 is usable, and limit types of transactions, as examples.

An access manager 222 may associate a payment card (debit or credit card) or a set of checks with each subaccount 100 based on the user input. Multiple access devices 300 may be linked to a single subaccount 100. Payment cards bear a respective account number and a name of a respective subaccount holder based on the user input. When selected by the account holder, the access manager 222 may subject payment cards to one or more use filters 218 selected by the account holder. A card generator 224 may create new payment cards for the subaccounts 100, under the account holder's control. Alternatively, the access manager 222 may assign a respective newly generated account number 210 to each of the one or more subaccounts 100 from a stock of preprinted payment cards (e.g., received from a bank or clearinghouse), each card having a predetermined account number. The access manager 222 then activates the relevant payment cards, and can inactivate payment cards too.

Example Operations

Fractional banking, as described herein, encompasses systems 200 and methods 700 & 800 & 800, for example, for dividing or partitioning a single financial account, such as a bank account or a credit account, into constituent subaccount parts. Each subaccount 100 an be treated as its own fully functional credit account, for example, with assigned credit and spending parameters. In an implementation, the total assets of the constituent subaccounts 100 can exactly equal the assets of the original master bank account or master credit account.

Fractional banking provides some benefits. For security, subaccounts 100 can contain or limit the damage of a compromised account to one isolated part of the master account. For accounting purposes, subaccounts 100 may be created for categorizing specific costs or specific purposes. With regard to spending, rules 220 can be custom-established to control spending across the subaccounts 100. Notifications and alerts can be configured for simple or complex situations. The creation of replacement or additional credit cards can be nearly instantaneous. Being able to create multiple subaccounts 100 also provides control and flexibility in the manner that financial assets are deployed. Privacy can also be enhanced, when the account holder frequently replaces cards to prevent merchant tracking.

Each time a credit card is used, the entire credit balance is at risk if the card information is stolen. Conventional systems do not allow the account holder to dynamically assign credit to individual cards. Conventional systems also do not allow the account holder to expose only a portion of their credit to a merchant when making a purchase.

The practices of the fractional banking described herein allow the account holder far more flexibility in the use of their financial assets (e.g., credit, debt, investments, and deposits) in a way more suitable to the their circumstances and preferences. An example fractional banking system with individual subaccounts 100 can be created and tailored within seconds by the account holder.

An example fractional credit account can be subdivided into a number of smaller accounts 100, each with its own available credit and spending characteristics. These characteristics can be easily managed through the user interface 208, deployed for example by a smart phone application, web account access, by bank kiosk, or by similar measures, and can dynamically allocate deposits and credits at the direction of the cardholder.

Judicious use of real-time purchase information allows for real-time monitoring and the application of spending filters 218 (e.g., “no purchase over $100 from 11 PM to 6 AM;” or “no purchases without a physical credit card present”) to safeguard the intent of the account holder.

The Basic Credit Card Cycle

When a credit card is presented to a merchant for authorization of purchase in a payment process, the data flows from the merchant's terminal, to the merchant's bank (the acquiring bank), though a clearinghouse (e.g., VISA), the cardholder's bank (the issuing bank), then in reverse back to the merchant's terminal.

In the cycle, there are at least four factors that are vulnerable to potential exploits by thieves exist. They are:

1. Information necessary to make purchases (card information) is fixed and relatively easy to steal.

2. The payment process places the entire available credit at risk in each transaction.

3. The payment process is blind to specific intentions of the cardholder.

4. The payment process is the same for both legitimate and fraudulent transactions.

An analysis of each factor leads to potential solutions. First, a pre-set amount of data is transmitted to the cardholder's bank for authorization of purchase (a retail level I transaction request). This data can be copied directly from the card, from the merchant's terminal, or anywhere along the transmission process. Recent advances, such as the “EMV chip” are attempts to circumvent a “fixed” set of data by adding a random text string which must be present upon making a level I transaction. This requires new terminals and new software to be compatible with the credit card cycle. The potential for fraud continues to exist since EMV chips do not validate CNP (card-not-present, i.e., internet) transactions.

Another solution is to change out the cardholder's 16-digit PAN (primary account number, i.e., the “credit card number”) on a routine basis. This makes the stolen credit card data time sensitive.

Second, stolen credit card information gives the thief the potential to charge up to the existing credit limit of the account. Conventionally, the cardholder cannot dynamically change the amount of credit assigned to the account. On the other hand, in the example fractional banking system 200 the cardholder can limit or dynamically change the amount of credit assigned to a subaccount 100 backing the credit card, thereby limiting theft when a credit card is stolen.

Third, credit card “fraud” is a judgment that can only be made by the cardholder. That is, only the cardholder can know and claim if the cardholder intended or did not intent to authorize a purchase. Banks can employ elaborate heuristics (behavioral) systems to make educated guesses as to the fraudulence of any given transaction, but cannot know for certain without contacting the cardholder. Timeliness prevents this from happening. Banks can shut down the account until they can contact the cardholder but this also can cause inconvenience.

Lastly, the credit card authorization system works exactly the same for a fraudulent transaction as it does for a legitimate transaction. There is no way of knowing that an attempted purchase is valid or invalid by looking at the transaction dataset itself.

The fractional banking system 200 presented herein is a novel approach to increase security and account flexibility of a credit card account (and cash accounts too) by addressing the four factors cited above.

The example fractional banking system 200 can be implemented for a credit account, and can be customized to include “intent” filters 218 & 220 to prevent fraudulent transactions.

Fractional banking techniques are not limited to credit accounts. The principles can be applied to other financial accounts (cash, debit, checking, equities/securities, etc.). For sake of description, credit accounts are described representatively on behalf of other types of accounts too.

Typically an account holder at a financial institution can establish different kinds of accounts (e.g., checking, savings, credit, etc.). Each account is separate from the others and has a fixed amount of available assets (e.g., cash, credit, etc.).

Federal and State laws differ but in general, most insured financial accounts require that the account holder identify themselves and provide a tax ID Number or SSN upon the establishment of an account.

An example system 200 allows a single credit account (“master bank account”) to be broken or subdivided into many subaccounts 100, which, if taken in total, can have combined assets that exactly equal the assets of the original single (overall) credit account. All subaccounts 100 comply with existing law as they are parts of a single account. In other words, to existing conventional and legacy banking systems, the subaccounts 100 and their configurations can appear to be a conventional single account. The conventional banking system just sees a conventional single account.

Typical banking software for credit card accounting works with a computer record that contains account information (such as the unique primary account number [PAN]) and name of the account. Individual purchase authorizations are linked to this credit account through a hierarchical database or a relational database. Relational databases are often preferred by financial institutions that process a great number of transactions since the transaction data can be added to a given relational database quickly. Computer programs can be run at a later time to sort and correlate the relational database data tables into useful account reports (such as which transactions belong to which credit accounts).

Fractional Allocation of Credit

Fractional banking allows the cardholder to create multiple subaccounts 100 under the header of the main account. Each subaccount 100 is now a “child” (in a hierarchical database) or a “relation” (in a relational database) to the main account.

In a simplest case, there is one credit account and one subaccount 100. This arrangement operates similarly to current credit card accounts. More complex configurations allow the credit account to be broken into two or more subaccounts, each with its own designated credit limit, based on user input. Undesignated or unassigned credit remains available but cannot be accessed until assigned to a subaccount 100.

Subaccounts 100 can be created until there no longer exists any frangible asset. IF our example credit scenario is in USD (US dollars), a user can theoretically create subaccounts 100 until each subaccount 100 contains only $0.01 each (cannot divide one cent any further). But in practice, each subaccount 100 is configured to initially contain a reasonable amount of credit based upon expected use.

Partitioning a single account into multiple subaccounts 100 also allows the account holder an ability to assign each subaccount 100 its own portion of the total available credit. For example, if an account holder initially has $5,000 available credit and creates three subaccounts 100, she may choose to statically assign $4,000 available credit to the first subaccount 100 and $500 available credit to the second and third subaccounts 100.

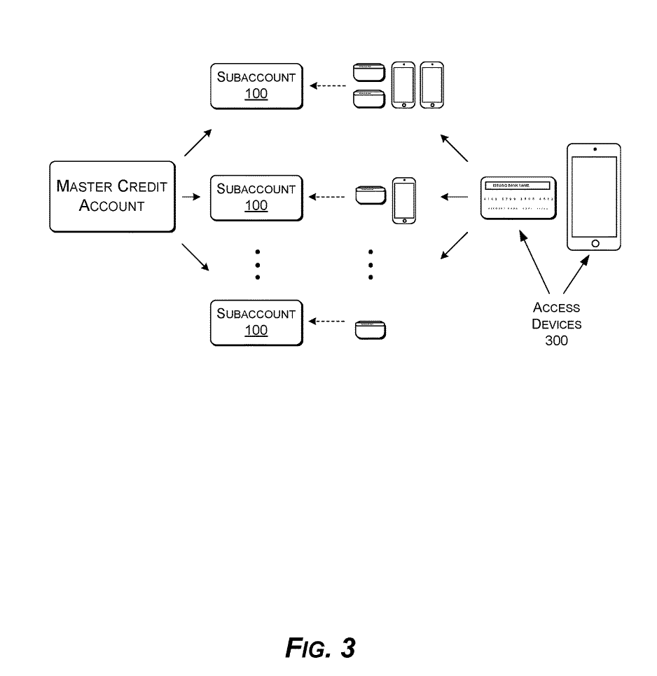

As shown in FIG. 3, at least one financial access device 300 is assigned to a given subaccount 100 in order to use the available credit. Subaccounts 100 can be assigned one or more access devices 300 (e.g., credit cards) to use the available credit assigned to each subaccount 100.

Financial Access Devices & Linking to Subaccounts

Bank financial assets (cash, credit, etc.) are kept at a bank. A financial access device 300 (F.A.D.) allows the account holder convenient access to financial assets remotely from the bank. For example, if an account holder has $10,000 of available credit, this credit exists at the financial institution. A credit card or a smart phone are classes of financial access devices 300 but they contain no money. These devices 300 allow the account holder to conveniently make a purchase at various merchants by tapping into their available credit. A debit card allows the account holder easy access to deposits (i.e., cash) stored at their bank.

Conventionally, credit cards and other access devices 300 are issued by the account holder's bank. Examples also include checkbooks, credit cards, debit cards, and internet applications.

In the example fractional banking system 200, the account holder can self-issue financial access devices 300 and link them to their own subaccounts 100, also created under the account holder's control.

Generating new accounts presupposes the account number generator or procurator 210. The format of a 16-digit primary account number (PAN) includes four different number sets. The “issuing number” is a five-digit number which uniquely identifies the issuing bank. This number is issued by the clearinghouse (e.g., Visa, MasterCard, Discover, American Express) and does not change. A Bank may have more than one issuing number. For example, Capital One Bank has issuing numbers of 14300-14399. The first digit is the clearinghouse to be used: 4 for Visa, 5 for MasterCard, and so forth. The last digit is a check-sum digit that is left over from the legacy paper-impression submissions.

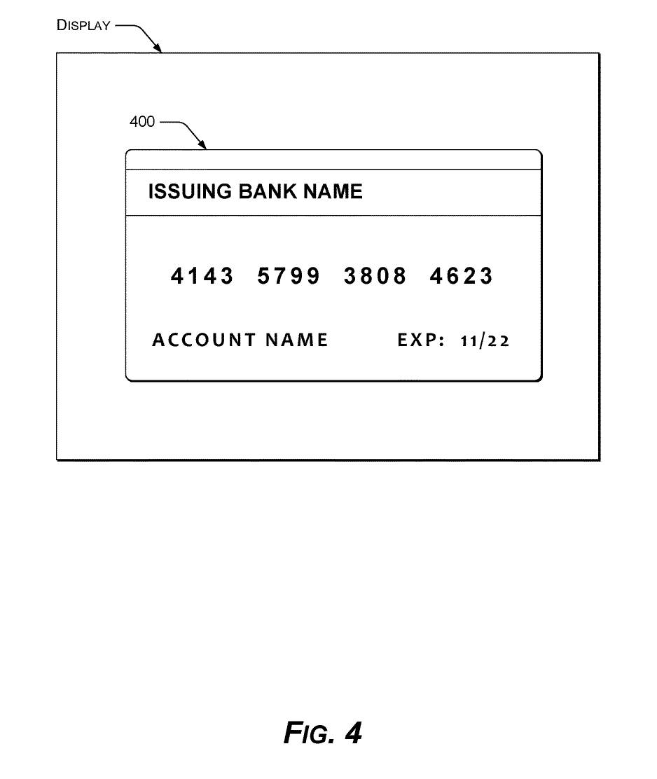

In the example fractional banking system 200, the self-issue of a credit card is a fairly straightforward process. In one implementation, the account number procurator 210 component of the example system 200 requests a new account number from the bank. A new credit card PAN (primary account number) may be generated ad hoc. The internal banking checks to be sure than the generated PAN is unique and not currently in use. As shown in FIG. 4, in an implementation, a graphic file 400 (e.g., .jpg or .png) representing the new card access device 300 can be constructed, for example by the card generator 224, and provided to the account holder immediately.

In an implementation of the example system 200, the self-issued example image 400 is a completely valid access tool 300. These virtual credit cards can be linked to a credit subaccount 100 and used immediately. If a physical card is desired, the issuing bank can generate it. Customization of the card, such as a background image, is simple.

Alternatively, in another implementation, a pre-generated physical card (or a stock of pre-figured credit cards) can be held in reserve and associated with a subaccount 100 when convenient for the account holder. For example, an issuing bank may sell or provide a set of 12 pre-manufactured credit cards (each with a unique 16 digit PAN containing the clearinghouse, the issuing bank number, account number, and checksum digit, text name, expiration date, and CVV code) and bearing custom logos, if desired. The account holder may choose to “activate” one of the cards when the need arises. For example, replacing a primary credit card monthly involves deactivating and discarding the currently active card then choosing a new card to activate.

The access devices 300 are tools to tap into the credit available in a single subaccount 100, but can be mixed and matched. However, in an implementation, these tools can also be moved from account to account according to the needs of the account holder. The methodology to move an access device 300 from one subaccount 100 to another is simple, because the database pointers to the subaccount 100 to which the access device 300 is linked is simply changed. All transactions made by an access device 300 drawing from a single subaccount 100 are logged & reconciled to that same subaccount 100.

The ability to move credit cards or other access devices 300 from one subaccount 100 to the another (under the authority of the account holder and subject to security verification) allows a single “tool” 300 to be used across multiple accounts 100. In this way, a single credit card (with a unique PAN) may show up on several different subaccounts 100 in the monthly statement. Payment cards (credit or debit) can therefore be dynamically assigned to subaccounts 100 as desired, one subaccount at a time, greatly simplifying expense accounting.

Providing the account holder the ability to self-issue access tools 300 (e.g., credit cards) has manifold consequences. Credit cards linked to a subaccount 100 may be deactivated or moved to another account 100. A smaller credit limit subaccount 100 can be set up for a child to learn to use credit responsibly. If mail security is a concern, then a deactivated card could be mailed to a relative and then activated and allotted cash by the account holder once it safely arrives. The account holder is free to use their cash or credit free of many conventional constraints from their issuing bank.

Self-Issuance & Risk Stratification

The account holder may now assign a risk assessment to a given subaccount 100. That is, for those subaccounts 100 designated for inherently more risky purposes (such as where the credit card is frequently out of their direct vision) then more rigid limits 218 can be set.

For example, if a waiter disappears with a credit card for an extended period of time the account holder may worry that the card or its information has been copied. After the meal the account holder can deactivate and replace the card instantly. Conventionally, the account holder has to contract their issuing bank for a new card to be issued in a time-consuming fashion. A psychological struggle for the account holder is weighing potential risk of a compromised credit account versus the inconvenience of being without a credit card for several days while they the card is being replaced.

Issuing Bank as Decision-Maker

The end point of a credit card transaction request is reached when the request arrives at the issuing bank. At this point in the cycle, the request has been through all other parties in the cycle and has been directed to the bank in which the account holder's credit resides.

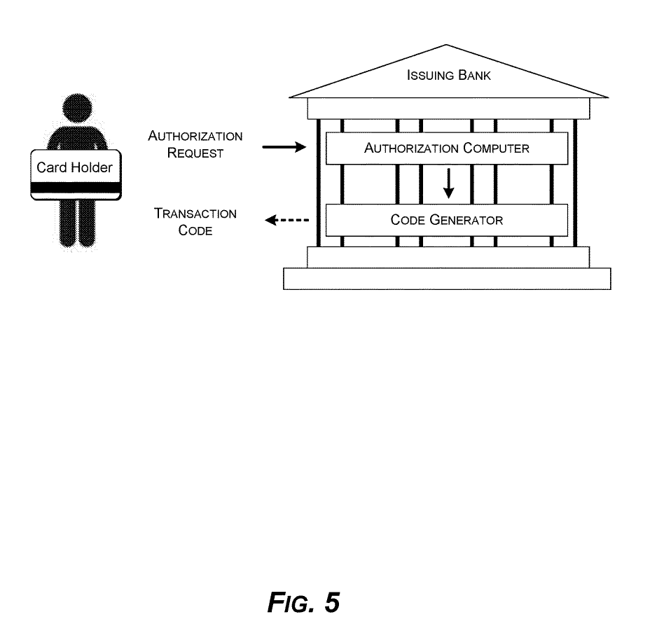

As shown in FIG. 5, a computing system inside the issuing bank (or proxy) called a “switch” receives the data request and begins the process of deciding if the request should be accepted or denied. This is a routine process (such as, “does the account exist?” and “is available credit present to cover the amount requested?” and “is there a hold on this account by the bank?”) and takes only a few seconds to complete. Banks may also run a heuristic routine (account behavior such as purchase patterns) as an added security check.

Once the process has completed the request is either “accepted” or “declined.” A new data packet is constructed and relayed back. The routing information on the incoming data packet ensures it returns to the exact terminal from which the request was sent. A response is always returned even if rejected to complete the credit card cycle and close the transaction request.

Fractional Credit Components

The example fractional banking system 200 can resides in the computing system of the issuing bank (or proxy). Human users primarily interact with the fractional account manager 206 component associated with the account management system 204 (AMS).

The AMS 204 is that portion of the example system 200 that allows the account holder to segment their master account into subaccounts 100 and apply custom parameters (such as credit limits, etc.) The AMS 204 is also where individual access devices 300 (e.g., credit cards) can be linked with subaccounts 100. The account holder is able to customize their subaccounts 100 at the issuing bank via kiosk, bank teller, website, smart phone application, automated phone system, and similar measures.

The portion of the example system 200 with which most humans do not interact is the decision support system (DSS) 202 which resides in the computer system handling the incoming transaction requests. The transactions arriving at the bank are automatically processed according to prescribed methods.

The example fractional banking system 200 provides additional analysis of the transaction request. In all circumstances the DSS 202 can produce three outcomes:

1. An accepted request can be changed to a denied request

2. A notification can be sent to the account holder, issuing bank, or both

3. The subaccount 100 may change its status to active or inactive

It is important to note that the example fractional banking system 200 never converts a denied request into an accepted request. The use of this denial is only to deny a transaction or send a notification or change the status of the subaccount 100.

The example fractional credit system 200 gives the account holder more control over the use of their own cash or credit by allowing the account holder to place additional criteria 218 & 220 on how assets are spent.

For example, if it is the decision of the account holder that a particular subaccount 100 should not allow any purchases between 9 AM and 1 PM, then a simple rule 220 can be established in a subaccount parameters table that denies transaction requests arriving at the issuing bank (or proxy) between those times. The transaction request may have cleared all standard checks but the decision support system 202 will decline the transaction since it has fallen outside the bounds of use.

A large number of use filters 218 can be constructed which act as a stand-in for the account holder. In an implementation, the account holder may access and configure an extensive list of such parameters via a website or smart phone application. A subaccount parameters table can act as the “intent” proxy for the account holder. In an implementation, use filters 218 are constructed in a manner that a positive response results in a declination of the request. That is, the logic of the request may be “is the purchase between 9 AM and 1 PM?” rather than, “is the purchase between 1:01 PM and 8:59 AM?”

The Decisions Support System (DSS) Tracks Complex Information

In an implementation, complex combinations of criteria can be configured for tracking clusters of transactions in particular situations. For example, it is possible to track the number of purchases in a given time frame such as the last 24 hours, or the total dollar amount spent on the last 5 purchases.

Tracking an amalgamation of information allows the account holder to be notified regarding situations not possible with simple transactional alerts. For example, if a subaccount 100 and associated credit card are intended only to pay for high school lunch for a single student then the transaction amount may not trigger the simple filter of “is the transaction more than $10?” as long as every transaction is under $10. However, if the card is misused and more than one lunch is purchased it may trigger the “more than $20 spend on one calendar day” alert.

Notifications that are Meaningful can Catch Fraud More Quickly

Timely notification is necessary to ensure that account holder intent is being followed. Immediate feedback on every transaction is tedious and quickly results in the account holder ignoring notifications.

The decision support system (DSS) 202 can run in real-time as the transaction request is being processed. The DSS 202 can notify the account holder within seconds of a transaction that violates a pre-set decision alert. The account holder will be able to notify the issuing bank (via smart phone app or similar) that there may be potential fraud. The ability to quickly cancel and replace a credit card greatly reduces the burden of fraud on the account holder.

A smart phone application can be used to alert the account holder of a potential problem and can be configured to allow the account holder the option to suspend a subaccount 100 or delink the associated credit card so that no further purchases can be made. Reporting fraud can be configured via the smart phone application as a single swipe and confirmation to relay the information to the issuing bank.

Monthly Payments and Severability

Fractionating a single account into many smaller subaccounts 100 seems like it would lead to confusion when the monthly statement comes. This is not necessarily the case.

For cash-based accounts the accounting is a simple tabulation of what was spent and what accounts the payments came from. The totals can be subtotaled and grand totaled.

For credit-based accounts the accounting is also simple with each subaccount 100 listing purchases and which access device 300 (e.g., credit card) was used. The use of subaccounts 100 and different access devices 300 may actually make the accounting easier to understand especially for small businesses.

It is important to remember that the multiple credit accounts, no matter how many subaccounts 100 are created, can still appear as a single master credit account to the bank's system. The sum of all the available credit, used credit, and purchases exactly adds up to the assets of the original master credit account.

One purpose of partitioning a single master bank account into multiple subaccounts 100 is to create barriers between the subaccounts 100 so that risk is limited to the assigned credit. This is the legal principle of severability (salvatorius), where an entity can be divided into independent pieces that can stand on their own. Fractional banking accomplishes the principle of severability for credit accounts in many ways except perhaps sometimes the monthly reconciliation payment.

The master credit account is still considered a single account to the bank and a monthly payment is required by the bank to consider the account whole. In an implementation, nonpayment of any portion of any of the subaccounts 100 makes the entire master credit account delinquent.

In an implementation, the account holder is responsible for the monthly payment for the subaccounts 100. If any subaccount is not made whole (via a monthly reconciliation payment), then the entire account, including all subaccounts, is considered delinquent and finance charges will apply.

In an implementation, fractional banking makes it possible to enforce severability on subaccounts 100 so that only a small finance charge occurs. However, this can be a departure from standard banking practice. The accounting necessary to treat individual credit subaccounts 100 as severable is straightforward. A fee for providing such a service can be charged since it is common banking practice to charge a finance fee on the credit extended in a given month even if only $0.01 is left unpaid. For example, if an account holder has $5,000 of available credit and $3,000 is used in a given month, if the reconciliation payment is mistakenly $2,995 ($5 short of full payment), the issuing bank may charge interest on the entire $3,000 and not the unpaid $5.

Applying severability to an account holder's credit subaccounts 100 can pose a serious threat to the profitably of the credit industry. Therefore, a monthly fee can be applied to severable subaccounts 100.

Credit Subaccounts and Severability

As introduced above, the example fractional banking does not have to impede reconciliation for cash or checking subaccounts 100. When a full payment is made for an example fractional credit account then no charges may incur, however, the actual reconciliation can be problematic in some instances. The difficulty lies in how the assigned credit of each subaccount 100 is to be recharged.

This can be illustrated by an example: consider three credit subaccounts 100 with a total of $5,000 available credit. The first subaccount [A] is assigned $3,000 credit, the second subaccount [B] and the third subaccount [C] each assigned $1,000. Suppose that subaccount [A] spends $2,500, subaccount [B] spends $300, and subaccount [C] spends $800, as in Table (1) below.

TABLE 1

| Subaccount | Spent | Remaining Credit |
|---|---|---|
| A | $2500 | $500 |
| B | $300 | $700 |
| C | $800 | $200 |

If the billing cycle is completed at the end of the month and a full payment is received then all accounts are recharged fully. A potential problem lies when purchases are made after the end of the month but before the payment is received and applied. In an example scenario, a monthly billing cycle is completed on the 30th of the month and an invoice for payment is sent, received, and paid ten days later. Referring to Table (2), when the payment is to be applied to the account, how is the payment distributed among the various accounts if purchases continue to be made in the intervening time?

TABLE 2

| | | Remaining | Spent Since | Revised Remaining |
|---|---|---|---|---|
| Subaccount | Spent | Credit | End of Month | Credit |
| A | $2500 | $500 | $250 | $250 |
| B | $300 | $700 | $300 | $400 |
| C | $800 | $200 | $200 | $0 |

How should payment be applied when the funds become available to the account holder's credit account, now that the total spent is $4,350 instead of the original invoice for $3,600?

There are numerous ways in which the distribution of the available funds can be applied to the subaccounts 100. Each method is based upon different assumptions such as priority, proportionality, percentage used, percentage remaining, minimum/maximum funding priorities, mixtures of proportionate and fixed funding, and recursive attempts to distribute evenly. The account holder can compare the various funding methods and choose the best that fits the given situation. Finally the account holder may choose to manually assign the available credit herself.

Moving Transactions Between Subaccounts

Subaccounts 100 can be created to make accounting of transactions easier and create a firewall between each subaccount 100. Compromised security of one subaccount 100 should present no risk to other subaccounts 100.

The creation of partitions within a single master credit account to create subaccounts 100 does not mean that a given transaction does not belong to the greater whole of the master bank account. The movement of a specific credit transaction (e.g., a rental car and hotel purchase) made under one subaccount 100 created for “groceries” can be moved into another subaccount 100 created for “travel expenses.”

The example fractional banking allows specific transactions to be moved between subaccounts with account holder authorization (e.g., a password). The transaction record will contain information regarding the original purchase under the “groceries” subaccount 100 but the available credit limit will be adjusted for both accounts upon movement. Discrepancies can be resolved if there is insufficient assigned credit to allow the movement of a specific transactions.

Self-Issuance of Debit/Cash Cards

Many debit cards display a major clearinghouse logo (Visa, Mastercard, etc.) and can be used as either credit or debit cards. The merchant's terminal may prompt the user to choose debit or credit. Depending on selections made by the cardholder, different networks may be used, a PIN required, and different transfer and finance fees may apply. It should be understood that a credit card can be converted to a debit card by simply designating it to be so at the issuing bank. Therefore pre-printed credit cards that can be used to link to credit subaccounts 100 may also be used to link to a single cash account as well.

If an account holder wishes to issue a payment card as a debit card (aka pre-paid cash card or gift card) the account holder can create a subaccount 100, assign cash or credit, then link an access device 300 (i.e., virtual credit card image or physical credit card) to the subaccount 100. If credit is assigned then it must be converted to cash before release, typically there is a cash-advance fee (3%-5%). Assigning credit instead of cash can result in a credit transaction request issued and accepted by the issuing bank.

At this point in the example, the subaccount 100 has been created, funded with cash, and linked with an access device 300. The pre-paid cash card may now be used within the account holder's bank account.

There are circumstances in which the account holder may want to surrender the card to another person (e.g., given as a gift). For reasons of risk exposure, the subaccount can be “spun off” the account holder's credit or cash account to a separate account area under the control of the issuing bank. The pre-paid cash card can continue to work until available funds are exhausted or an arbitrary expiration date is reached. Unless claimed by the recipient of the pre-paid cash card the tax ID/SSN of the account holder who created the cash card remains on the account. Unspent funds at the end of expiration are credited back to the creator of the card.

Moving Subaccounts Between Account Holders

In an implementation, an account holder may wish to transfer funds from her own account to another person. If an existing subaccount 100 with a linked access device 300 (i.e., a credit card) is surrendered to another person at the same issuing bank the subaccount 100 can be pruned off and grafted into a second account holder's account.

This activity is acknowledged by both parties (an invitation is sent via smart-phone application or online, for example, then received and accepted). The transfer is recorded as a transaction request issued and accepted by the issuing bank. Transaction records appear in each account holder's accounts.

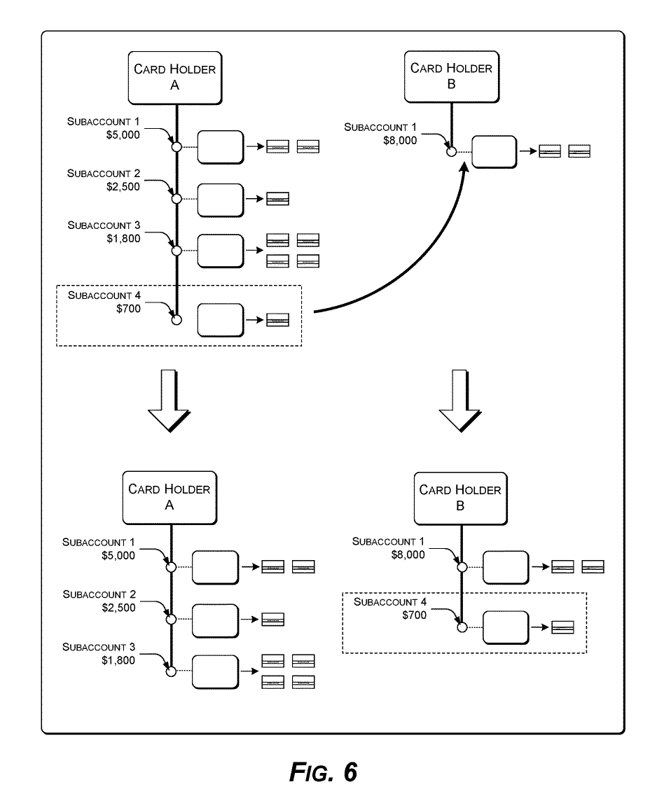

FIG. 6 shows example corpuscular movement of a single subaccount 100 to new card holder account.

In an implementation, both parties must be using the example fractional banking system 200 and both using the same issuing bank. The access device 300 (e.g., a credit card) will not function at all if the recipient's bank does not have the same 5-digit issuing number for credit cards.

Pre-Paid Cash Card Anonymity & Privacy

Pre-Paid cash cards offer an advantage over credit cards in that they are typically short lived (days to months) and can blind merchants as to card holder buying habits. Credit cards, with persistent 2-4 year expiration limits and unchanging card number, can be used to track account holder purchases.

Pre-paid cash cards offer an advantage over credit cards in that they do not use money that is not available (no credit offered). Further, they can be used for online purchases whereas cash cannot. The use of self-issued pre-paid cash cards can become more popular as the example fractional banking system 200 makes them easier to issue. In one scenario, the example cash cards may be traded at par value (a $50 cash card is offered for $50 in return for cash).

It may be in the interest of the account holder to isolate herself from any generated pre-paid cash card that is to be surrender to anyone else. At the same time, the issuing bank and cardholder must comply with State and Federal law.

As introduced above, a pre-paid cash card may be spun off into an account area of the issuing bank not under control of the account holder. The recipient of the pre-paid cash card may log into a public version of the issuing bank's Account Management System 204 (via a smart phone application or website and register their card. This allows the recipient to determine their account balances and check the status of the card to be assured that it is not being monitored by the issuer of the card.

Tumbling and Privacy

In the example fractional banking system 200, pre-paid cash cards may be two separate entities: a funded cash account at the issuing bank and a linked access device 300 (a cash card). The cash card holder may seek additional anonymity by changing either her account number or access device.

If the card holder seeks to change the account number then she may request a “tumble” in which a new account is created with a different account number, and all funds moved to the new account, with the old account number closed, and in one example, released for re-use.

Various methods can be used to secure this technique (encryption, public key encryption, two party encryption) but this is not done to avoid legal oversight. The process of tumbling the account is traceable but may require bank officials to manually enter encryption keys to decode. The technique is meant to make it much harder for unauthorized access (i.e., hackers) to gain access to the identity of card holders. The fractional banking principles still apply to pre-paid cash cards and tumbled accounts. The access devices 300 may be changed at any time.

Example Methods

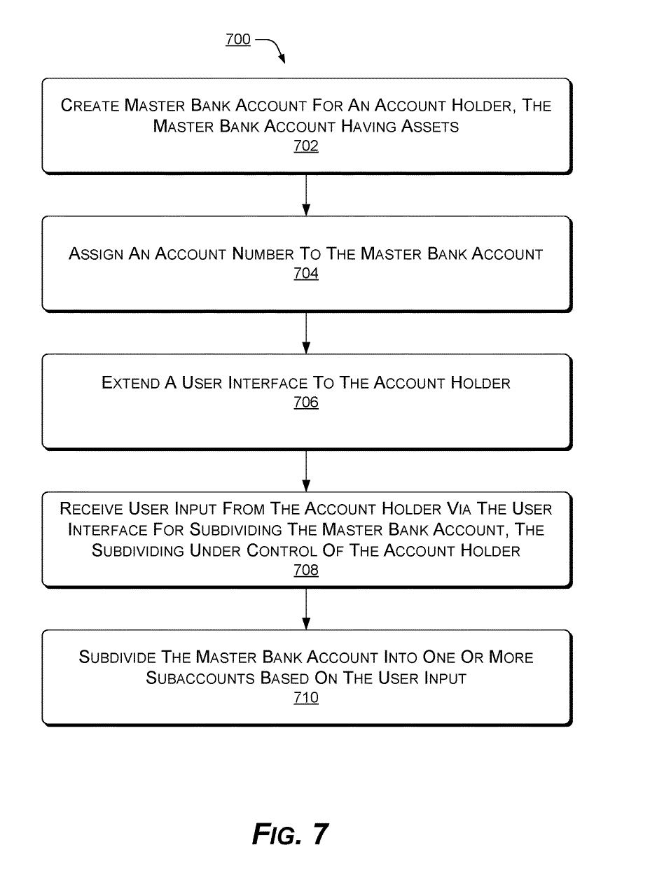

FIG. 7 shows one example method 700 of fractional banking. Operations of the example method 700 are shown in individual blocks. The example method 700 may be executed by hardware, such as the example banking system 200 of FIG. 2.

At block 702, a master bank account having assets is created for an account holder.

At block 704, an account number is assigned to the master bank account.

At block 706, a user interface is extended to the account holder.

At block 708, user input is received from the account holder for subdividing the master bank account into subaccounts.

At block 710, the master bank account is subdivided into one or more subaccounts based on the user input.

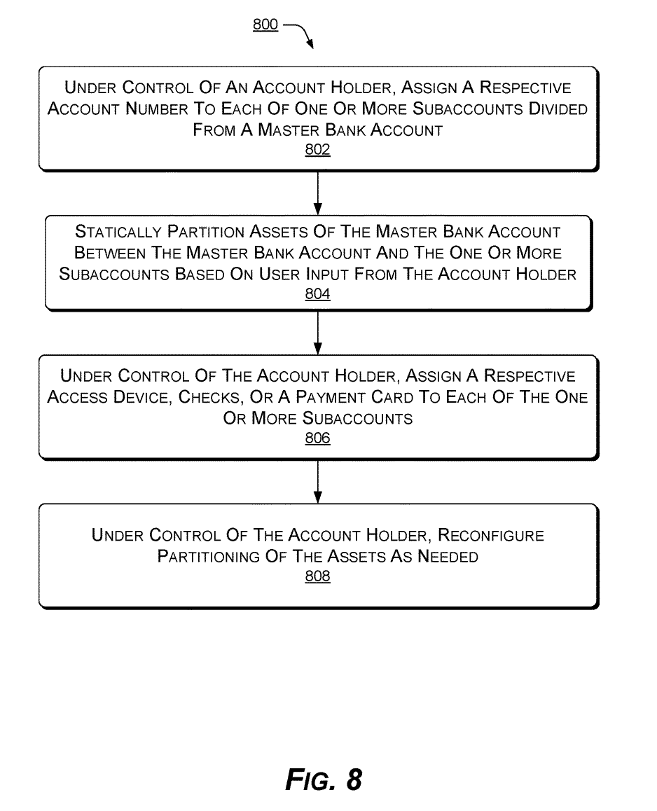

FIG. 8 shows an example method 800 of configuring subaccounts in fractional banking. Operations of the example method 800 are shown in individual blocks. The example method 800 may be executed by hardware, such as the example banking system 200 of FIG. 2.

At block 802, a respective account number is assigned to each or one or more subaccounts divided from a master bank account based on user input.

At block 804, assets of the master bank account are statically partitioned between the master bank account and the one or more subaccounts based on user input from the account holder.

At block 806, a respective access device, a set of checks, or a payment card is assigned to each of the one or more subaccounts.

At block 808, the static partitioning of the assets is reconfigured by the account holder, as needed.

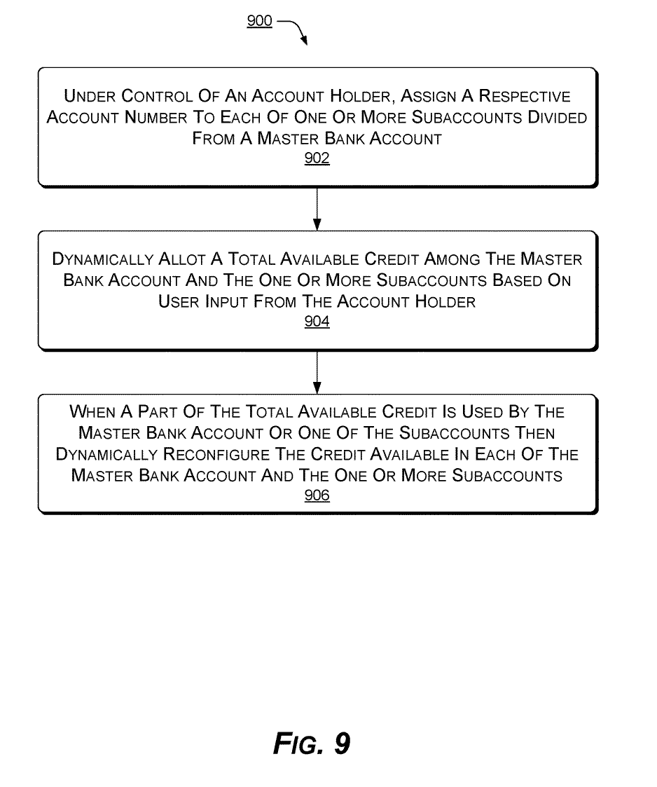

FIG. 9 shows another example method 900 of configuring subaccounts in fractional banking. Operations of the example method 900 are shown in individual blocks. The example method 900 may be executed by hardware, such as the example banking system 200 of FIG. 2.

At block 902, a respective account number is assigned to each of one or more subaccounts divided from a master bank account, based on user input from an account holder.

At block 904, a total available credit is dynamically allotted among the master bank account and the one or more subaccounts, based on the user input.

At block 906, when a part of the total available credit is used by the master bank account or one of the one or more subaccounts, the credit available is dynamically reconfigured in the master account and in each of the one or more subaccounts.

The example method 900 is just one example, showing dynamic allotment. The total available credit may also be statically partitioned, as illustrated in FIG. 8. A cash balance may also be statically partitioned between accounts, or dynamically allotted among the accounts.

In the foregoing description and in the accompanying drawings, specific terminology and drawing symbols have been set forth to provide a thorough understanding of the disclosed embodiments. In some instances, the terminology and symbols may imply specific details that are not required to practice those embodiments. For example, any of the specific dimensions, quantities, material types, fabrication steps and the like can be different from those described above in alternative embodiments. The term “coupled” is used herein to express a direct connection as well as a connection through one or more intervening circuits or structures. The terms “example,” “embodiment,” and “implementation” are used to express an example, not a preference or requirement. Also, the terms “may” and “can” are used interchangeably to denote optional (permissible) subject matter. The absence of either term should not be construed as meaning that a given feature or technique is required.

Various modifications and changes can be made to the embodiments presented herein without departing from the broader spirit and scope of the disclosure. For example, features or aspects of any of the embodiments can be applied in combination with any other of the embodiments or in place of counterpart features or aspects thereof. Accordingly, the specification and drawings are to be regarded in an illustrative rather than a restrictive sense.

1. A method, comprising:
creating a master bank account for a user, the master bank account having assets;
assigning an account number to the master bank account;
extending a user interface to the user, wherein the user is an account holder;
receiving user input from the user interface for subdividing the master bank account, the subdividing under control of the user; and
subdividing a part of the master bank account into one or more subaccounts based on the user input.

2. The method of claim 1, further comprising:
assigning a respective account number or alphanumeric string to each of the one or more subaccounts;
assigning a respective access device, checks, or a payment card to each of the one or more subaccounts based on the user input; and
allotting an asset of the master bank account to at least one of the one or more subaccounts based on the user input.

3. The method of claim 2, wherein the asset of the master bank account comprises at least part of a cash balance or at least part of a total available credit.

4. The method of claim 2, wherein the assets of the master bank account are statically partitioned between the master bank account and the one or more subaccounts, based on the user input.

5. The method of claim 2, wherein the asset of the master bank account comprises a total available credit and the total available credit is statically partitioned between the master bank account and the one or more subaccounts, based on the user input.

6. The method of claim 2, wherein the assets of the master bank account comprise a cash balance and the assets are dynamically allotted between the master bank account and the one or more subaccounts based on the user input;
wherein the master bank account and the one or more subaccounts use the assets on a first-come-first-serve basis; and
wherein a use of at least part of the assets by the master bank account or the one or more subaccounts dynamically decreases the amount of the assets available to the master bank account and the one or more subaccounts.

7. The method of claim 2, wherein the asset of the master bank account comprises a total available credit and the total available credit is dynamically allotted between the master bank account and the one or more subaccounts based on the user input;
wherein the master bank account and the one or more subaccounts use remaining total available credit on a first-come-first-serve basis; and
wherein a use of at least part of the total available credit by the master bank account or the one or more subaccounts dynamically decreases the amount of the total available credit available to the master bank account and the one or more subaccounts.

8. The method of claim 2, further comprising statically partitioning selected amounts of the assets for use in one or more selected accounts of the master bank account and the one or more subaccounts based on the user input; and
dynamically allotting the remaining assets among one or more remaining accounts of the master bank account and the one or more subaccounts based on the user input.

9. The method of claim 2, further comprising applying a use filter on one of the subaccounts based on the user input, the use filter selected from the group consisting of a spending rule, a restriction on dates that the subaccount may be used, a restriction on hours of the day that the subaccount may be used, a restriction on a location where the subaccount may be used, a restriction on an amount that can be spent or charged during certain hours, and a limit on types of transactions.

10. The method of claim 2, further comprising assigning at least one of the one or more subaccounts to a different account user or an additional account user than the account user.

11. The method of claim 2, further comprising:
generating a payment card as the access device for each respective subaccount based on the user input, wherein the payment card bears the respective account number and a name of a respective subaccount holder based on the user input; and
when selected by the user, subjecting the payment card to one or more use filters selected by the user.

12. The method of claim 2, further comprising assigning the respective account number to each of the one or more subaccounts from a stock of preprinted payment cards, the stock of preprinted payment cards having predetermined account numbers.

13. A system, comprising:
a decision support system associated with a bank;
an account management system coupled with the decision support system, the account management system administering a master bank account for an account holder;
a fractional account manager associated with the account management system, the fractional account manager under control of the account holder;
a user interface extendable from the fractional account manager to the account holder for receiving selections as user input; and
a accounts configuration engine for subdividing a part of the master bank account into one or more subaccounts, based on the user input.

14. The system of claim 13, wherein the accounts configuration engine assigns a respective account number to each of the one or more subaccounts;
wherein the accounts configuration engine assigns a respective access device, a set of checks, or a payment card to each of the one or more subaccounts based on the user input; and
wherein the accounts configuration engine allots an asset of the master bank account to at least one of the one or more subaccounts based on the user input.

15. The system of claim 14, further comprising a static partitioner to divide total assets of the master bank account statically between the master bank account and the one or more subaccounts based on the user input.

16. The system of claim 15, wherein assets of the master bank account comprise a total available credit and the total available credit is statically partitioned between the master bank account and the one or more subaccounts based on the user input.

17. The system of claim 14, further comprising a dynamic allotment engine to dynamically assign assets of the master bank account between the master bank account and the one or more subaccounts based on the user input;
wherein the dynamic allotment engine allots the assets to the master bank account and to each of the one or more subaccounts on a first-come-first-serve basis; and
wherein when at least part of the assets are used by the master bank account or the one or more subaccounts the dynamic allotment engine dynamically adjusts a respective available credit for each of the master bank account and the one or more subaccounts.

18. The system of claim 14, further comprising one or more filters applicable to a use of one of the subaccounts based on the user input, each use filter selected from the group consisting of a spending rule, a restriction on dates that the subaccount may be used, a restriction on hours of the day that the subaccount may be used, a restriction on a location where the subaccount may be used, a restriction on an amount that can be spent or charged during certain hours, and a limit on types of transactions.

19. The system of claim 14, further comprising an access manager for associating or creating a payment card or a set of checks for each subaccount based on the user input, the payment card bearing the respective account number and a name of a respective subaccount holder based on the user input; and
wherein when selected by the user, the access generator subjects the payment card to one or more use filters selected by the user.

20. The system of claim 19, wherein the access manager assigns the respective account number to each of the one or more subaccounts from a stock of preprinted payment cards, the stock of preprinted payment cards having predetermined account numbers.
